(19) United States
(12) Patent Application Publication
(10) Pub. No.: US 2016/0253435 A1
(43) Pub. Date: Sep. 1, 2016

(54) DESIGN SUPPORT PROGRAM AND STRUCTURAL CALCULATION PROGRAM

(71) Applicant: Hitachi Metals Techno, Ltd., Tokyo (JP)

(72) Inventors: Hidenori TANAKA, Tokyo (JP); Hisatomo MOCHIDUKI, Tokyo (JP); Kousuke FUKUCHI, Tokyo (JP)

(21) Appl. No.: 14/346,371

(22) PCT Filed: Sep. 27, 2013
(86) PCT No.: PCT/JP2013/076294

§ 371 Date: Mar. 21, 2014

(51) Int. Cl. G06F 17/50

(52) U.S. Cl. CPC G06F 17/50

(57) ABSTRACT

In a design support program used for designing a column base structure having a column base portion, and a column member joined to a joint metal fitting, the column base portion yields before the column member, a design basis strength F1′ of the joint metal fitting is smaller than a design basis strength F2 of the column member, and the design support program calculates an index bending bearing force of the column member by multiplying a bending bearing force of the column member by a value obtained by dividing F1′ by F2, compares a bending bearing force of the column base portion with the index bending bearing force, and sets the bending bearing force of the column base portion to a final bending bearing force of the column base structure in the case that the bending bearing force thereof is smaller than the index bending bearing force.

### BACKGROUND OF THE INVENTION

1. Field of the Invention

The present invention relates to a design support program and a structural calculation program which are used in a design of a column base structure or a building construction provided with the column base structure, the column base structure being structured such that a joint metal fitting arranged above a base concrete has a column base portion which is fixed to a leading end portion of an anchor bolt protruding upward from an inside of the base concrete, and a column member which is joined its lower end portion to an upper surface of the joint metal fitting.

2. Description of the Conventional Art

FIGS. 8 to 10 are views which are referred for explaining a conventional column base structure 2 which is designed by using a conventional structural calculation program, and a conventional structural calculation device employing the structural calculation program, and a building construction which is provided with the conventional column base structure 2.

The conventional column base structure 2 is structured, as shown in FIG. 8, such as to be provided with a column base portion 5 which is provided on a base concrete 3, and a steel frame column 4 (a column member) which is joined its lower end portion to a joint metal fitting 6 of the column base portion 5. The column base portion 5 has the joint metal fitting 6, a mortar 8, an anchor bolt 10, nut members 12 and 14, a washer 16 and a fixing plate 18.

The column base portion 5 of the conventional column base structure 2 is structured such that the tabular joint metal fitting 6 having both front and back faces is provided above the base concrete 3 via the mortar 8. The joint metal fitting 6 of the column base portion 5 is made of a metal, and a lower end portion of the steel frame column 4 having a length in a vertical direction in the drawing is joined by welding to an upper surface 6a (a front surface) thereof.

Here, in FIG. 8, as a matter of convenience for description, a weld portion W is not drawn in a surface in a near side of the drawing of the steel frame column 4, however, the weld portion W is formed in the surface in the near side and the surface in the back side of the drawing, in the same manner as two side surfaces which are adjacent to these surfaces. Same applied to the other drawings such as FIGS. 9 and 10 in this regard.

Further, an upper end portion of the anchor bolt 10 protruding upward from the inner side of the base concrete 3 is inserted to a bolt through hole 6b in a peripheral edge portion of the joint metal fitting 6 and a through hole of the washer 16. A male thread portion formed in an upper end portion of the anchor bolt 10 is threadably fastened to female thread portions of two nut members 12, whereby the steel frame column 4 is fixed to the weld portion W while standing on the base concrete 3 via the joint metal fitting 6 of the column base portion 5 and the mortar 8 (refer, for example, to patent document 1).

Further, the male thread portion formed in the lower end portion of the anchor bolt 10 is loosely inserted to the through hole passing through in a thickness direction of the fixing plate 18 and is threadably fastened to the female thread portion of the nut member 14 in the upper surface side and the lower surface side of the fixing plate 18, in the base concrete 3, whereby the fixing plate 18 is integrally fixed to the lower end portion of the anchor bolt 10 in the base concrete 3.

Further, as the other conventional column base structure, there has been a column base structure employing a joint metal fitting having a different shape from a simple tabular shape, the joint metal fitting being constructed by a bottom plate portion, and a support table portion which is higher upward in a center portion of an upper surface of the base plate portion than a peripheral edge portion thereof and is formed as a trapezoidal shape, and being structured such that a lower end portion of a steel frame column is joined by welding to an upper surface of the support table portion, in place of the joint metal fitting 6 mentioned above (refer, for example, to patent document 2).

The conventional column base structure according to the patent document 2 is structured such that the upper end portion of the anchor bolt protruding upward from the inner side of the base concrete is inserted to the bolt insertion hole passing through in the thickness direction of the peripheral edge portion of the bottom plate portion in the joint metal fitting, and the male thread portion formed in the anchor bolt is threadably fastened to the female thread portion of the nut member, whereby the steel frame column is fixed to the weld portion while standing on the base concrete via the joint metal fitting of the column base portion and the mortar.

In the meantime, a building construction provided with the conventional column base structure 2 (refer to FIG. 8) is structured such that one having a weaker bearing force of the steel frame column 4 and the column base portion 5 in the column base structure 2 yield in advance so as to plastically deform, in the case that a load generating a great bending moment M is applied so as to rotate the steel frame column 4 in a clockwise direction around a center O of rotation of the center portion between a pair of weld portions W to the joint metal fitting 6 in both side surfaces of the steel frame column 4, as shown in FIG. 9.

In the building construction provided with the conventional column base structure 2 mentioned above, in order to make the column base portion 5 yield before the steel frame column 4 so as to plastically deform, it is necessary to make the bearing force against the bending moment M of the column base portion 5 larger than the bearing force of the steel frame column 4.

Here, a bearing force (including a bending bearing force Mp and an axial bearing force Np mentioned later) of the steel frame column 4 is defined by a design basis strength F2 of the steel frame column 4, and the greater the design basis strength F2 of the steel frame column 4 is, the greater the bearing force of the steel frame column 4 is.

On the contrary, a bearing force (including a bending bearing force Mu and an axial bearing force Nu mentioned later) of the column base portion 5 is not defined by a design basis strength F1 of the joint metal fitting 6, but is defined by a strength of the joint metal fitting 6, a strength of the anchor bolt 10, and a fixing performance of the joint metal fitting 6 to the base concrete 3 via the mortar 8, the anchor bolt 10, the nut members 12 and 14, the washer 16 and the fixing plate 18.

Further, in the case that the conventional column base structure 2 is sectioned into two structures constructed by a column base structure 2A in which the design basis strength F1 of the joint metal fitting 6 is equal to or more than the design basis strength F2 of the steel frame column 4, and a column base structure 2B in which the design basis strength F1 of the joint metal fitting 6 is smaller than the design basis strength F2 of the steel frame column 4, the column base structure 2A has been widely employed conventionally.

In the case that a load generating a great bending moment M which intends to rotate the steel frame column 4 is applied to the steel frame column 4 in the conventional column base structure 2B mentioned above, in a clockwise direction around a center O of rotation of the center portion between a pair of weld portions W of the steel frame column 4 to the joint metal fitting 6, as shown in FIG. 10, the weld portion W joining the steel frame column 4 to the joint metal fitting 6 of the column base portion 5 locally yields, so that there is fear that the weld portion W is broken and the steel frame column 4 and the joint metal fitting 6 of the column base portion 5 are separated.

On the other hand, in the case that the load generating the great bending moment M which intends to rotate the steel frame column 4 is applied to the steel frame column 4 in the conventional column base structure 2A mentioned above, in a clockwise direction around the center O of rotation of the center portion between a pair of weld portions W of the steel frame column 4 to the joint metal fitting 6, as shown in FIG. 9, the steel frame column 4 is bent in the clockwise direction at a portion above the weld portion W in place of the yielding of the weld portion W joining the steel frame column 4 to the joint metal fitting 6, so that there is not the fear that the weld portion W is broken and the steel frame column 4 and the joint metal fitting 6 of the column base portion 5 are separated.

As a result, in the case of designing the building construction provided with the conventional column base structure 2, the design basis strength F1 of the joint metal fitting 6 is equal to or more than the design basis strength F2 of the steel frame column 4.

Further, in the building construction provided with the conventional column base structure 2, a structural calculation thereof is carried out by a conventional structural calculation device using a conventional structural calculation program.

Here, the structural calculation program continuously carries out a calculation defined by Building Standard Law such as various bearing force determinations, a calculation of allowable stress and a calculation of critical bearing force, and admission decision thereof, on the basis of input data such as a scale and a shape of the building construction, a material and a dimension of the column base structure in the building construction and a beam and a column which construct an upper structure above the column base structure, and various load data, for example, a fixed load and a live load, and displays and/or prints all the results thereof in the structural calculation device.

Further, in the conventional structural calculation device, the values of the bending bearing force Mp and the axial bearing force Np of the steel frame column 4, the bending bearing force Mu and the axial bearing force Nu of the column base portion 5 are calculated by the conventional design support program which is embedded in the conventional structural calculation program on the basis of the input data, the smaller one of the bending bearing force Mp of the steel frame column 4 and the bending bearing force Mu of the column base portion 5 is employed as a final bending bearing force Ms of the column base structure 2.

Further, the structural calculation of the building construction is carried out by employing the final bending bearing force Ms which is decided in the conventional design support program, as a reference of the admission decision, according to the conventional structural calculation program.

### PRIOR ART DOCUMENT

### Patent Document

Patent Document 1: Japanese Unexamined Patent Publication No. 2003-232078
Patent Document 2: Japanese Unexamined Patent Publication No. 2003-336266

### SUMMARY OF THE INVENTION

### Problem to be Solved by the Invention

In recent years, a high strength of the steel frame column 4 is going to be progressed, and a high strength material having a greater value of the design basis strength F2 is going to be employed as the material of the steel frame column 4. As a result, in order to make the design basis strength F1 of the joint metal fitting 6 larger than the design basis strength F2 of the steel frame column 4, it is necessary to employ the high strength material having the greater value of the design basis strength F1 as the material of the joint metal fitting 6. Therefore, there is a problem that a manufacturing cost of the joint metal fitting 6 becomes higher, and a manufacturing cost of the conventional column base structure 2 employing the joint metal fitting 6 becomes higher.

Accordingly, the present invention is made by taking the problem mentioned above into consideration, and an object of the present invention is to provide a design support program and a structural calculation program which can be used for designing a column base structure which can prevent a joint portion between a joint metal fitting and a column member from locally yielding and prevent the joint portion from being broken, in the case that a load generating a bending moment is applied due to an earthquake, and can prevent a manufacturing cost of the joint metal fitting and the column base structure from becoming higher.

### Means for Solving the Problem

In order to achieve the object mentioned above, a design support program according to the present invention is a design support program used for designing a column base structure provided with a column base portion in which a joint metal fitting arranged above a base concrete is fixed to an anchor bolt protruding upward from the base concrete, and a column member which is joined its lower end portion to an upper surface of the joint metal fitting,

wherein the column base portion is set to yield before the column member according to an increase of a load which is applied to the column base structure,

wherein a design basis strength of the joint metal fitting is set to be smaller than a design basis strength of the column member, and

wherein the design support program comprises:

a step of calculating an index bending bearing force of the column member by multiplying a bending bearing force of the column member by a value obtained by dividing the design basis strength of the joint metal fitting by the design basis strength of the column member;

a step of comparing the bending bearing force of the column base portion with the index bending bearing force of the column member; and

a step of setting the bending bearing force of the column base portion to a final bending bearing force of the column base structure in the case that the bending bearing force of the column base portion is smaller than the index bending bearing force of the column member.

Further, in order to achieve the object mentioned above, a structural calculation program according to the present invention is a structural calculation program used for designing a building construction provided with a column base structure having a column base portion in which a joint metal fitting arranged above a base concrete is fixed to an anchor bolt protruding upward from the base concrete, and a column member which is joined its lower end portion to an upper surface of the joint metal fitting,

wherein the column base portion is set to yield before the column member according to an increase of a load which is applied to the column base structure,

wherein a design basis strength of the joint metal fitting is set to be smaller than a design basis strength of the column member, and

wherein the structural calculation program comprises:

a step of calculating an index bending bearing force of the column member by multiplying a bending bearing force of the column member by a value obtained by dividing the design basis strength of the joint metal fitting by the design basis strength of the column member;

a step of comparing the bending bearing force of the column base portion with the index bending bearing force of the column member;

a step of setting the bending bearing force of the column base portion to a final bending bearing force of the column base structure in the case that the bending bearing force of the column base portion is smaller than the index bending bearing force of the column member; and

a step of carrying out a structural calculation of the building construction provided with the column base structure by using the final bending bearing force of the column base structure.

Further, a structural calculation program according to the present invention is a structural calculation program used for designing a building construction provided with a column base structure having a column base portion in which a joint metal fitting arranged above a base concrete is fixed to an anchor bolt protruding upward from the base concrete, and a column member which is joined its lower end portion to an upper surface of the joint metal fitting,

wherein the column base portion is set to yield before the column member according to an increase of a load which is applied to the column base structure,

wherein a design basis strength of the joint metal fitting is set to be smaller than a design basis strength of the column member, and

wherein the structural calculation program comprises:

a step of calculating an index bending bearing force of the column member by multiplying a bending bearing force of the column member by a value obtained by dividing the design basis strength of the joint metal fitting by the design basis strength of the column member;

a step of carrying out a structural calculation of a first virtual building construction provided with the column base structure by employing an index bending bearing force of the column member as a final bending bearing force of the column base structure;

a step of carrying out a structural calculation of a second virtual building construction in which the final bending bearing force of the column base structure in the first virtual building construction is changed to the bending bearing force of the column base portion;

a step of comparing respective structure bearing forces between the first virtual building construction and the second virtual building construction; and

a step of setting the structure bearing force of the second virtual building construction to the structure bearing force of the building construction provided with the column base structure, in the case that the structure bearing force of the virtual building construction is smaller than the structure bearing force of the first virtual building construction.

### Effect of the Invention

According to the design support program of the present invention mentioned above, in the design support program used for designing the column base structure provided with the column base portion in which the joint metal fitting arranged above the base concrete is fixed to the anchor bolt protruding upward from the base concrete, and the column member which is joined its lower end portion to the upper surface of the joint metal fitting, the column base portion is set to yield before the column member according to the increase of the load which is applied to the column base structure, the design basis strength of the joint metal fitting is set to be smaller than the design basis strength of the column member, and the design support program comprises the step of calculating the index bending bearing force of the column member by multiplying the bending bearing force of the column member by the value obtained by dividing the design basis strength of the joint metal fitting by the design basis strength of the column member, the step of comparing the bending bearing force of the column base portion with the index bending bearing force of the column member, and the step of setting the bending bearing force of the column base portion to the final bending bearing force of the column base structure in the case that the bending bearing force of the column base portion is smaller than the index bending bearing force of the column member. Therefore, it is possible to be used for designing the column base structure which can prevent the joint portion between the joint metal fitting and the column member from locally yielding and prevent the joint portion from being broken, in the case that the load generating the bending moment is applied due to the earthquake, and can prevent the manufacturing cost of the joint metal fitting and the column base structure from becoming higher.

Further, according to the structural calculation program of the present invention, in the structural calculation program used for designing the building construction provided with the column base structure having the column base portion in which the joint metal fitting arranged above the base concrete is fixed to the anchor bolt protruding upward from the base concrete, and the column member which is joined its lower end portion to the upper surface of the joint metal fitting, the column base portion is set to yield before the column member according to the increase of the load which is applied to the column base structure, the design basis strength of the joint metal fitting is set to be smaller than the design basis strength of the column member, and the structural calculation program comprises the step of calculating the index bending bearing force of the column member by multiplying the bending bearing force of the column member by the value obtained by dividing the design basis strength of the joint metal fitting by the design basis strength of the column member, the step of comparing the bending bearing force of the column base portion with the index bending bearing force of the column member, the step of setting the bending bearing force of the column base portion to the final bending bearing force of the column base structure in the case that the bending bearing force of the column base portion is smaller than the index bending bearing force of the column member, and the step of carrying out the structural calculation of the building construction provided with the column base structure by using the final bending bearing force of the column base structure. Therefore, it is possible to be used for designing the column base structure which can prevent the joint portion between the joint metal fitting and the column member from locally yielding and prevent the joint portion from being broken, in the case that the load generating the bending moment is applied due to the earthquake, and can prevent the manufacturing cost of the joint metal fitting and the column base structure from becoming higher.

Further, according to the structural calculation program of the present invention, in the structural calculation program used for designing the building construction provided with the column base structure having the column base portion in which the joint metal fitting arranged above the base concrete is fixed to the anchor bolt protruding upward from the base concrete, and the column member which is joined its lower end portion to the upper surface of the joint metal fitting, the column base portion is set to yield before the column member according to the increase of the load which is applied to the column base structure, the design basis strength of the joint metal fitting is set to be smaller than the design basis strength of the column member, and the structural calculation program comprises the step of calculating the index bending bearing force of the column member by multiplying the bending bearing force of the column member by the value obtained by dividing the design basis strength of the joint metal fitting by the design basis strength of the column member, the step of carrying out the structural calculation of the first virtual building construction provided with the column base structure by employing the index bending bearing force of the column member as the final bending bearing force of the column base structure, the step of carrying out the structural calculation of the second virtual building construction in which the final bending bearing force of the column base structure in the first virtual building construction is changed to the bending bearing force of the column base portion, the step of comparing the respective structure bearing forces between the first virtual building construction and the second virtual building construction, and the step of setting the structure bearing force of the second virtual building construction to the structure bearing force of the building construction provided with the column base structure, in the case that the structure bearing force of the virtual building construction is smaller than the structure bearing force of the first virtual building construction. Therefore, it is possible to be used for designing the column base structure which can prevent the joint portion between the joint metal fitting and the column member from locally yielding and prevent the joint portion from being broken, in the case that the load generating the bending moment is applied due to the earthquake, and can prevent the manufacturing cost of the joint metal fitting and the column base structure from becoming higher.

### BRIEF EXPLANATION OF THE DRAWINGS

FIG. 1 is a partly cross sectional side elevational view showing a column base structure 40 which is designed by a design support program 50 and a structural calculation program 52 according to a first embodiment of the present invention, and a structural calculation device 54 using them;

FIG. 2 is a conceptual side elevational view for explaining a state in which a load generating a bending moment M is applied in the column base structure 40 shown in FIG. 1;

FIG. 3 is a schematic block diagram of the structural calculation device 54 which is used for designing a building construction provided with the column base structure 40 shown in FIG. 1;

FIG. 4 is a flow chart of the design support program 50 which is used at the time of designing a building construction provided with the column base structure 40 shown in FIG. 1;

FIG. 5 is a flow chart of the structural calculation program 52 which is used at the time of designing the building construction provided with the column base structure 40 shown in FIG. 1;

FIG. 6 is a partly cross sectional side elevational view showing a column base structure 70 which is designed by a design support program 50 and a structural calculation program 52 according to a second embodiment of the present invention, and a structural calculation device 54 using them;

FIG. 7 is a flow chart of a structural calculation program 80 which is used at the time of designing a building construction provided with the column base structure 70 shown in FIG. 7;

FIG. 8 is a partly cross sectional side elevational view showing a conventional column base structure 2, 2A or 2B which is designed by a conventional structural calculation program and a conventional structural calculation device using it;

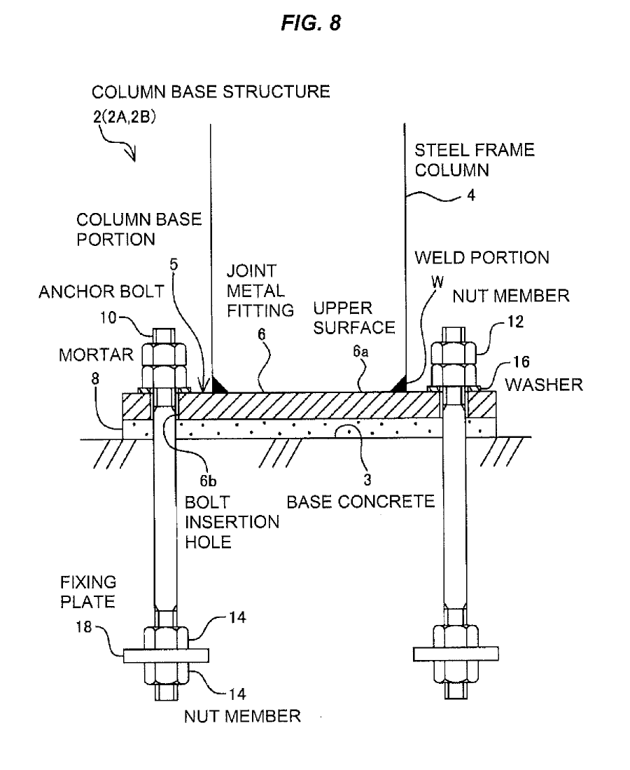

FIG. 9 is a conceptual side elevational view for explaining a state in which a load generating a bending moment M is applied in the conventional column base structure 2A shown in FIG. 8; and

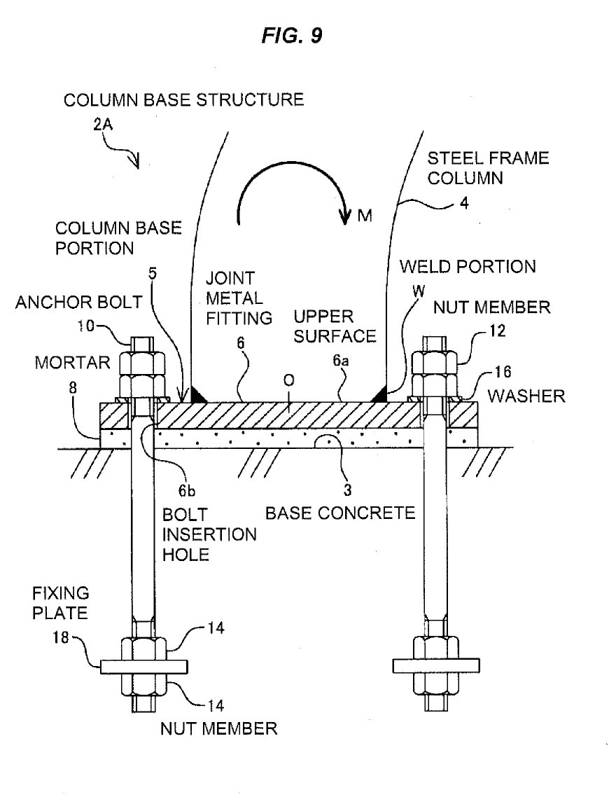

FIG. 10 is a conceptual side elevational view for explaining a state in which a load generating a bending moment M is applied in the conventional column base structure 2B shown in FIG. 8.

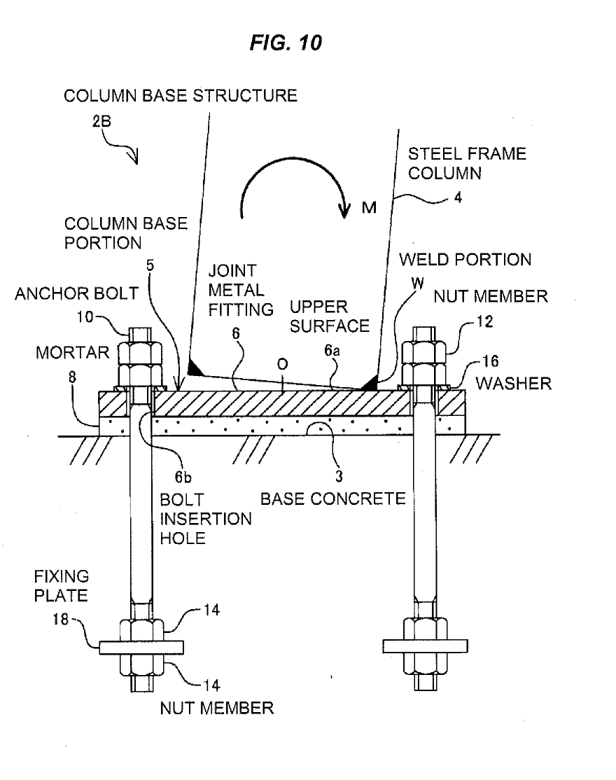

### DESCRIPTION OF REFERENCE NUMERALS

2, 2A, 2B column base structure
3 base concrete
4 steel frame column
5 column base portion
6 joint metal fitting
6a upper surface
6b bolt insertion hole
8 mortar
10 anchor bolt
12, 14 nut member
16 washer
18 fixing plate
40 column base structure
41 column base portion
42 joint metal fitting
42a upper surface
42b bolt insertion hole
50 design support program
52 structural calculation program
54 structural calculation device
56 memory portion
58 arithmetic processing portion
60 control portion
62 input portion
64 output portion
66 input means
68 output means
70 column base structure
71 column base portion
72 joint metal fitting
72a bottom plate portion
72b upper surface
72c bolt insertion hole
72d support table portion
72e upper surface
80 structural calculation program
82 structural calculation device
A, B virtual building construction
F1 design basis strength of joint metal fitting 6
F1′ design basis strength of joint metal fitting 42
F2 design basis strength of steel frame column 4
M bending moment
Mp bending bearing force of steel frame column 4
Mp′ index bending bearing force of steel frame column 4
Mu bending bearing force of column base portion 5
Mu′ bending bearing force of column base portion 41
Mu′ bending bearing force of column base portion 71
Np axial bearing force of steel frame column 4
Np′ index axial bearing force of steel frame column 4
Nu axial bearing force of column base portion 5
Ms design final bending bearing force
P, Pa, Pb structural bearing force of building construction provided with column base structure 70
W weld portion

### DETAILED DESCRIPTION OF PREFERRED EMBODIMENTS

A description will be specifically given below of a mode for carrying out a column base structure which is designed by a design support program and a structural calculation program according to the present invention, and a structural calculation device using them, and a building construction provided with the column base structure, with reference to the accompanying drawings.

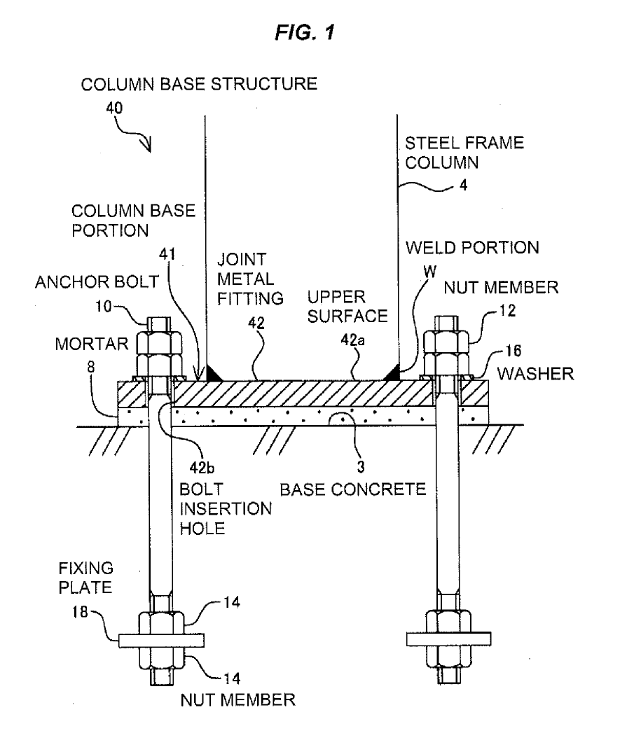

FIGS. 1 to 5 are views which are referred for explaining a column base structure 40 which is designed by a design support program 50 and a structural calculation program 52 according to a first embodiment of the present invention, and a structural calculation device 54 using them.

Hereinafter, a description will be given by attaching the same reference numerals to the same portions as those in the conventional column base structure 2 which is designed by the conventional structural calculation program and the conventional structural calculation device using it, and the building construction provided with the conventional column base structure 2, and an overlapping description of the same structures as the conventional ones will be omitted except a part of them.

The column base structure 40 in the present embodiment is structured such as to be provided with a column base portion 41 which is provided on a base concrete 3, and a steel frame column 4 (a column member) which is joined its lower end portion to a joint metal fitting 42 of the column base portion 41, as shown in FIG. 1. The column base portion 41 has a joint metal fitting 42, a mortar 8, anchor bolts 10, nut members 12 and 14, washers 16 and fixing plates 18.

In the column base portion 41 of the column base structure 40 in the present embodiment, the tabular joint metal fitting 42 is provided above the base structure 3 via the mortar 8. The joint metal fitting 42 is made of a metal and has both front and back square surfaces.

In the joint metal fitting 42 of the column base portion 41, a lower end portion of the steel frame column 4 is brought into contact with an upper surface 42a thereof, and the joint metal fitting 42 and the steel frame column 4 are joined by welding in weld portions W. The steel frame column 4 has a length in a vertical direction in FIG. 1 and is formed as a hollow rectangular tubular shape.

Further, an upper end portion of the anchor bolt 10 protruding upward from an inner side of the base concrete 3 is inserted into a bolt insertion hole 42b which is formed in a peripheral edge portion of the joint metal fitting 42.

A male thread portion which protrudes upward in relation to the joint metal fitting 42 and is formed in the upper end portion of the anchor bolt 10 is inserted to a through hole of the washer 16 and is threadably fastened to a female thread portion of the nut member 12, whereby the steel frame column 4 is provided in a rising manner on the base concrete 3 via the weld portion W, the joint metal fitting 42 of the column base portion 41 and the mortar 8 so as to be fixed.

The column base structure 40 in the present embodiment is set such that a design basis strength F1′ of the joint metal fitting 42 is smaller than a design basis strength F2 of the steel frame column 4.

Further, the column base structure 40 in the present embodiment is set such that a bending bearing force Mu′ of the column base portion 41 is smaller than an index bending bearing force Mp′ of the steel frame column 4.

Here, the bending bearing force Mu′ of the column base portion 41 is defined by a strength of the joint metal fitting 42, a strength of the anchor bolt 10, and a fixing performance of the joint metal fitting 42 to the base concrete 3 via the mortar 8, the anchor bolt 10, the nut members 12 and 14, the washer 16 and the fixing plate 18, in the same manner as the bending bearing force Mu of the column base portion 5 in the conventional column base structure 2.

On the contrary, the index bending bearing force Mp′ of the steel frame column 4 is calculated by multiplying the bending bearing force Mp of the steel frame column 4 by a value obtained by dividing the design basis strength F1′ of the joint metal fitting 42 by the design basis strength F2 of the steel frame column 4.

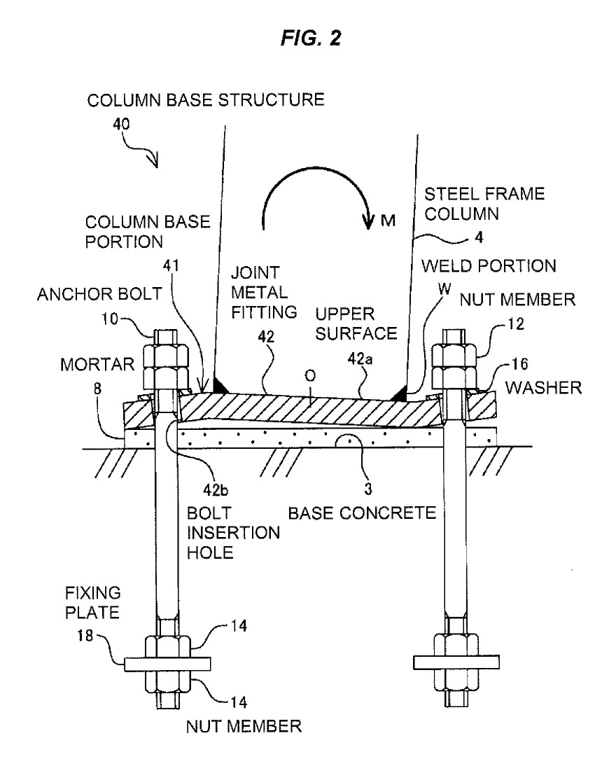

The column base structure 40 in the present embodiment is structured such that the joint metal fitting 42 yields and plastically deforms, without local yielding of the weld portion W joining the steel frame column 4 and the joint metal fitting 42 and breakage of the weld portion W, in the case that a load generating a great bending moment M is applied to the steel frame column 4 in a clockwise direction around a center O of rotation of the center portion between a pair of weld portions W to the joint metal fitting 42, as shown in FIG. 2, by making the bending bearing force Mu′ of the column base portion 41 smaller than the index bending bearing force Mp′ of the steel frame column 4.

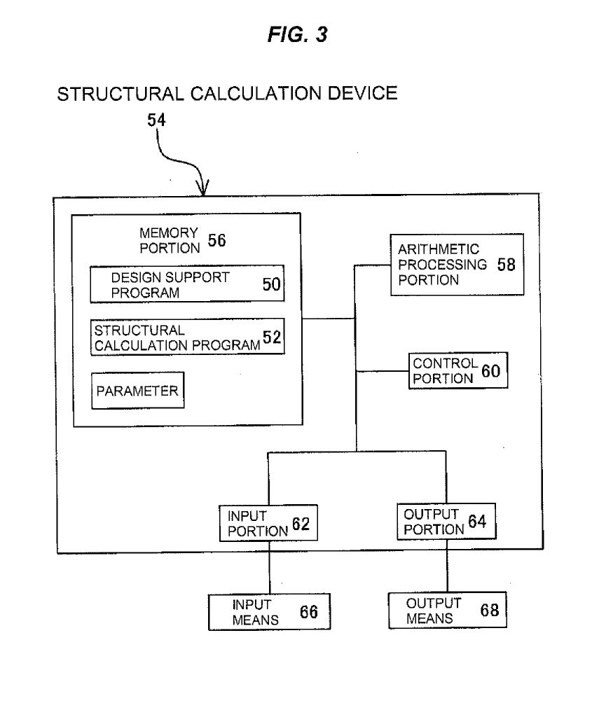

In the building construction provided with the column base structure 40 in the present embodiment mentioned above, a structural calculation thereof is carried out by the structural calculation device 54 which uses the design support program 50 and the structural calculation program 52, as shown in FIG. 3, and a dimension of each of members is decided.

The structural calculation device 54 is structured such as to be provided with a memory portion 56, an arithmetic processing portion 58, a control portion 60, an input portion 62 and an output portion 64. Further, in the structural calculation device 54, an input means 66 is detachably connected to the input portion 62 thereof, and an output means 68 is detachably connected to the output portion 64 thereof.

The memory portion 56 of the structural calculation device 54 stores the design support program 50, the structural calculation program 52, and parameters such as a scale and a shape of the building construction, a material and a dimension of beams and columns which construct the column base structure 40 in the building construction and an upper structure above the column base structure 40, and various load data, for example, a fixed load and a live load.

The arithmetic processing portion 58 of the structural calculation device 54 continuously carries out various bearing force determinations, calculation defined by Building Standard Law such as an allowable stress calculation and a critical bearing force calculation and an admission decision thereof, according to the design support program 50 and the structural calculation program 52.

The control portion 60 of the structural calculation device 54 carries out a control of interaction of signals and data among the memory portion 56, the arithmetic processing portion 58, the input means 66 connected to the input portion 62 and the output means 68 connected to the output portion 64, and a control of the arithmetic processing portion 58 along the design support program 50 and the structural calculation program 52.

As the input means 66 connected to the input portion 62 of the structural calculation device 54, there is an instructing and input means such as a keyboard and a mouse. Further, an information terminal such as an external memory device or a communication cable is connected to the input portion 62 of the structural calculation device 54, and the data can be transferred to the memory portion 56 from an outer portion of the structural calculation device 54.

Further, as the output means 68 connected to the output portion 64 of the structural calculation device 54, there are a display means such as a display, and a printing means such as a printer. Further, the information terminal such as the external memory device or the communication cable is connected to the output portion 64 of the structural calculation device 54, and the data can be transferred to the external portion from the memory portion 56 of the structural calculation device 54.

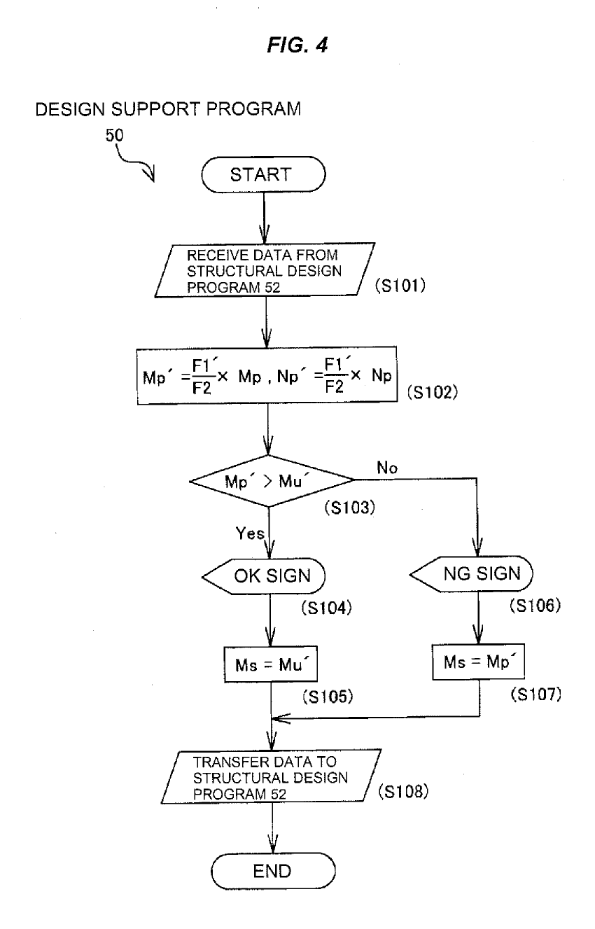

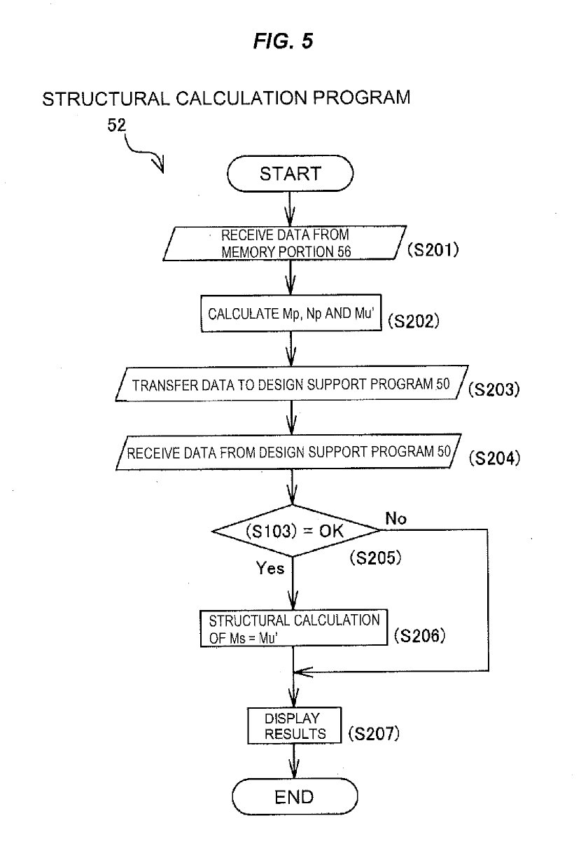

FIG. 4 is a flow chart showing an operation of the design support program 50, and FIG. 5 is a flow chart showing an operation of the structural calculation program 52.

First of all, the structural calculation program 52 receives the data such as the scale and the shape of the building construction, the material and the dimension of the beams and the columns constructing the column base structure 40 in the building construction and the upper structure above the column base structure 40, and the various load data, for example, the fixed load and the live load, from the parameter of the memory portion 56 (S201).

Further, in the arithmetic processing portion 58, a bending bearing force Mp and an axial bearing force Np of the steel frame column 4, and a bending bearing force Mu′ of the column base portion 41 are calculated on the basis of the data received in S201 (S202).

Values of the bending bearing force Mp and the axial bearing force Np of the steel frame column 4, and the bending bearing force Mu′ of the column base portion 41 are transferred to the design support program 50 from the structural calculation program 52 together with values of a design basis strength F1′ of the joint metal fitting 42, and a design basis strength F2 of the steel frame column 4 (S203 and S101).

Next, in the arithmetic processing portion 58, an index bending bearing force Mp′ of the steel frame column 4 is calculated by multiplying the bending bearing force Mp of the steel frame column 4 by a value obtained by dividing the design basis strength F1′ of the joint metal fitting 42 by the design basis strength F2 of the steel frame column 4 (S102).

Further, an index axial bearing force Np′ of the steel column 4 is calculated by multiplying the axial bearing force Np of the steel frame column 4 by the value obtained by dividing the design basis strength F1′ of the joint metal fitting 42 by the design basis strength F2 of the steel frame column 4 (S102).

Further, in the arithmetic processing portion 58, a large or small relationship is determined between the value of the index bending bearing force Mp′ of the steel frame column 4, and the bending bearing force Mu′ of the column base portion 41 (S103).

In the case that the value of the index bending bearing force Mp′ of the steel frame column 4 is larger than the bending bearing force Mu′ of the column base portion 41, an OK sign is displayed on a display together with these values (S104).

Further, a value of a design final bending bearing force Ms of the column base structure 40 comes to a value of the bending bearing force Mu′ of the column base portion 41 (S105).

On the contrary, in the case that the value of the index bending bearing force Mp′ of the steel frame column 4 is smaller than the bending bearing force Mu′ of the column base portion 41, an NG sign is displayed on the display together with these values (S106).

Further, the value of the design final bending bearing force Ms of the column base structure 40 comes to the value of the index bending bearing force Mp′ of the steel frame column 4 (S107).

The index bending bearing force Mp′ and the index axial bearing force Np′ of the steel frame column 4 in the step S102 of the design support program 50, the results of determination in the step S103, and the value of the design final bending bearing force Ms of the column base structure 40 in the steps S105 and S107 are transferred to the structural calculation program 52 from the design support program 50 (S108 and S204).

Further, the results of determination in the step S103 of the design support program 50 are referred, and it is determined whether it is OK or NG (S205).

In the case that the result of determination in the step S103 of the design support program 50 is OK, the structural calculation program 52 carries out the structural calculation of the building construction provided with the column base structure 40 by setting the bending bearing force Mu′ of the column base portion 41 to the final bending bearing force Ms of the column base structure 40, and employing the final bending bearing force Ms as a reference of the admission decision, thereby calculating the structure bearing force (including the bending bearing force and the axial bearing force) of the building construction provided with the column base structure 40 (S206).

The result of structural calculation in the step S206 of the structural calculation program 52 is displayed on the display (S207).

Further, in the case that the result of determination in the step S103 of the design support program 50 is NG, the fact is displayed on the display (S207).

According to the structural calculation device 54 using the design support program 50 and the structural calculation program 52 as mentioned above, the structural calculation is carried out by employing the bending bearing force Mu′ of the column base portion 41 which is smaller than the index bending bearing force Mp′ of the steel frame column 4 as the final bending bearing force Ms, and the dimension of each of the members of the building construction provided with the column base structure 40 is decided.

Further, since the structural calculation is carried out by employing the bending bearing force Mu′ of the column base portion 41 which is smaller than the index bending bearing force Mp′ of the steel frame column 4, the column base structure 40 according to the present embodiment can prevent the weld portion W joining the steel frame column 4 and the joint metal fitting 42 from locally yielding and prevent the weld portion W from being broken, in the case that the load generating the bending moment M is applied due to the earthquake shown in FIG. 2, even if the design basis strength Ft of the joint metal fitting 42 is smaller than the design basis strength F2 of the steel frame column 4.

Further, since the design basis strength Ft of the joint metal fitting 42 can be made smaller than the design basis strength F2 of the steel frame column 4, it is not necessary to employ a high strength material having a greater value of the design basis strength F1′ as a material of the joint metal fitting 42, even in the case that the high strength material having the greater value of the design basis strength F2 is employed as the material of the steel frame column 4.

As a result, the column base structure 40 according to the present embodiment can prevent the manufacturing cost of the joint metal fitting 42 from becoming higher, and can prevent the manufacturing cost of the column base structure 40 using the joint metal fitting 42 from becoming higher.

As described above, in the design support program 50 and the structural calculation program 52 according to the first embodiment of the present invention, and the column base structure 40 which is designed by the structural calculation device 54 using them, it is possible to prevent the joint portion (the weld portion W) between the joint metal fitting 42 and the steel frame column 4 from locally yielding and prevent the joint portion from being broken, in the case that the load generating the bending moment M is applied due to the earthquake, and it is possible to prevent the manufacturing cost of the joint metal fitting 42 and the column base structure 40 from becoming higher.

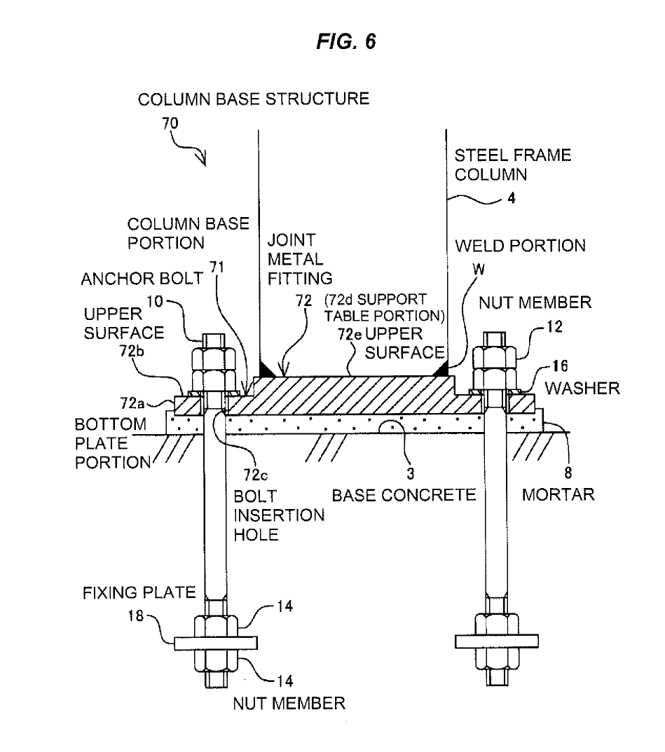

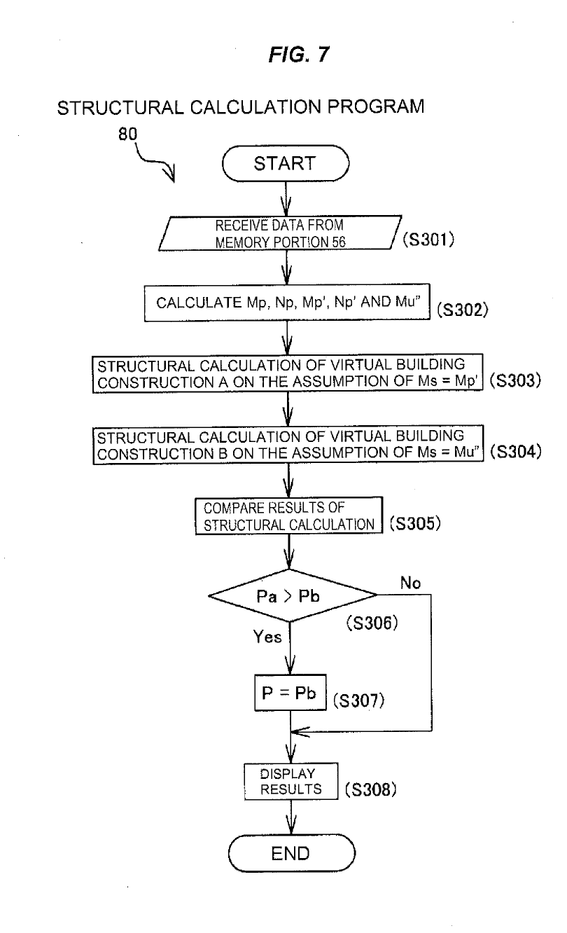

FIGS. 6 and 7 are views which are referred for explaining a structural calculation program 80 according to a second embodiment of the present invention, and a column base structure 70 designed by a structural calculation device using the structural calculation program 80 and a building construction provided with the column base structure 70.

The structural calculation program 80 according to the present embodiment and the column base structure 70 to be designed by the structural calculation device using the structural calculation program 80 is different from the column base structure 40 according to the first embodiment mentioned above in a point that the column base structure 70 is provided with a joint metal fitting 72 having a bottom plate portion 72a and a support table portion 72d as shown in FIG. 6, in place of the joint metal fitting 42 in the column base structure 40 to be designed according to the first embodiment.

In other words, the joint metal fitting 72 of the column base portion 71 in the present embodiment is made of a metal, and is constructed by the bottom plate portion 72a which has both front and back surfaces formed approximately as a square shape and is formed as a plate shape, and the support table portion 72d which is structured such that a center portion of an upper surface 72b of the bottom plate portion 72a has a height toward an upward direction in the drawing in relation to a peripheral edge portion thereof, as shown in FIG. 6.

The joint metal fitting 72 is joined to the steel frame column 4 in the weld portions W by welding, in such a manner that a lower end portion of the steel frame column 4 is brought into contact with an upper surface 72e of the support table portion 72d.

Further, an upper end portion of the anchor bolt 10 protruding upward from the inner side of the base concrete 3 is inserted to a bolt insertion hole 72c which is formed in the peripheral edge portion of the bottom plate portion 72a of the joint metal fitting 72.

A male thread portion which protrudes upward in relation to peripheral edge portion of the bottom plate portion 72a in the joint metal fitting 72 and is formed in the upper end portion of the anchor bolt 10 is inserted to a through hole of the washer 16 and is threadably fastened to a female thread portion of the nut member 12, whereby the steel frame column 4 is provided in a rising manner on the base concrete 3 via the weld portion W, the joint metal fitting 72 of the column base portion 71 and the mortar 8 so as to be fixed.

The column base structure 70 according to the present embodiment is set such that a design basis strength of the joint metal fitting 72 is smaller than the design basis strength F2 of the steel frame column 4, in the same manner as the column base structure 40 according to the first embodiment.

The column base structure 70 in the present embodiment is set such that a structure bearing force Pb of the building construction provided with the column base structure 70 is smaller than a structure bearing force Pa of the building construction provided with the column base structure 70, the structure bearing force Pb being calculated by setting a bending bearing force Mu″ of the column base portion 71 to a design final bending bearing force Ms, and the structure bearing force Pa being calculated by setting an index bending bearing force Mp′ of the steel frame column 4 to the design final bending bearing force Ms.

The column base structure 70 in the present embodiment is structured such that the joint metal fitting 72 yields and plastically deforms, without local yielding of the weld portion W joining the steel frame column 4 and the joint metal fitting 72 and breakage of the weld portion W, in the case that a load generating a great bending moment M is applied to the steel frame column 4, by making the structure bearing force Pb of the building construction provided with the column base structure 70 smaller than the structure bearing force Pa.

In the building construction provided with the column base structure 70 in the present embodiment mentioned above, a structural calculation thereof is carried out by the structural calculation device which is different from the structural calculation device 54 in the first embodiment in a point that the structural calculation program 80 is used in place of the design support program 50 and the structural calculation program 52 shown in FIG. 3, and a dimension of each of members is decided.

FIG. 7 is a flow chart showing an operation of the structural calculation program 80.

First of all, the structural calculation program 80 receives the data such as the scale and the shape of the building construction, the material and the dimension of the beams and the columns constructing the column base structure 40 in the building construction and the upper structure above the column base structure 40, and the various load data, for example, the fixed load and the live load, from the parameter of the memory portion 56 (S301).

Further, in the arithmetic processing portion 58, a bending bearing force Mp, an axial bearing force Np, an index bending bearing force Mp′ and an index axial bearing force Np′ of the steel frame column 4, and a bending bearing force Mu″ of the column base portion 71 are calculated on the basis of the data received in S301 (S302).

In the structural calculation program 80, a structural calculation of a virtual building construction A (a first virtual building construction) provided with the column base structure 70 is carried out by assuming the index bending bearing force Mp′ of the steel frame column 4 as the final bending bearing force Ms of the column base structure 70, and using the assumed final bending bearing force Ms as a reference for admission decision, and the structure bearing force Pa of the virtual building construction A is calculated (S303).

Further, in the structural calculation program 80, a structural calculation of a virtual building construction B (a second virtual building construction) provided with the column base structure 70 is carried out by assuming the bending bearing force Mu″ of the column base portion 71 as the final bending bearing force Ms of the column base structure 70, and using the assumed final bending bearing force Ms as the reference for admission decision, and the structure bearing force Pb of the virtual building construction B is calculated (S304).

Here, the virtual building construction A and the virtual building construction B are obtained by modeling the building construction provided with the column base structure 70, and the virtual building constructions have the same structure as each other except the value of the final bending bearing force Ms.

Further, a large or small relationship of various bearing forces is determined by comparing the result of structural calculation of the virtual building construction A with the result of structural calculation of the virtual building construction B (S305).

Further, in the arithmetic processing portion 58, a large or small relationship is determined between the value Pa of the structure bearing force Pa of virtual building construction A, and the structure bearing force Pb of the virtual building construction B (S306).

In the case that the structure bearing force Pb of the virtual building construction B is smaller than the value Pa of the structure bearing force of the virtual building construction A, the value of the structure bearing force P of the building construction provided with the column base structure 70 comes to the value of the structure bearing force Pb of the virtual building construction B (S307).

Further, the results of structural calculation of the virtual building constructions A and B are displayed on the display (S308).

Further, in the case that the structure bearing force Pb of the virtual building construction B is smaller than the value Pa of the structure bearing force of the virtual building construction A, the OK sign is displayed on the display together with these values (S308).

On the contrary, in the case that the structure bearing force Pb of the virtual building construction B is smaller than the value Pa of the structure bearing force of the virtual building construction A, the NG sign is displayed on the display together with these values (S308).

Further, the structural calculation is carried out by setting the structure bearing force Pb of the virtual building construction B which is smaller than the value Pa of the structure bearing force of the virtual building construction A, to the structure bearing force P of the building construction provided with the column base structure 70, by the structural calculation device using the structural calculation program 80, and the dimension of each of the members of the building construction provided with the column base structure 70 is decided.

On the basis of the structural calculation program 80 according to the present embodiment, and the column base structure 70 designed by the structural calculation device using the structural calculation program 80, it is possible to prevent the joint portion (the weld portion W) between the joint metal fitting 72 and the steel frame column 4 from locally yielding and prevent the joint portion from being broken, in the case that the load generating the bending moment M is applied due to the earthquake, in the same manner as the column base structure 40 according to the first embodiment. Further, since it is not necessary to employ a high strength material having a greater design basis strength for the joint metal fitting, it is possible to prevent the manufacturing cost of the joint metal fitting 72 and the column base structure 70 provided with the same from becoming higher.

The present invention is not limited only to the embodiments mentioned above, but can be variously modified about the design support program, the structural calculation program, the structural calculation device, the column base structure to be designed by the structural calculation device, and the building construction provided with the column base structure, within a range that can achieve the object of the present invention.

For example, in the column base structure 40 to be designed by the design support program, the structural calculation program and the structural calculation device according to the first embodiment mentioned above, the description is given of the case that the joint metal fitting 42 has both the front and back surfaces formed approximately as the square shape and is formed as the tabular shape, however, both the front and back surfaces may be formed as the other rectangular shapes than the square and have different lengths vertically and transversely.

Further, the joint metal fitting 42 may be formed as a tabular shape having both front and back surfaces which are formed as the other polygonal shapes than the square or a circular shape. In this regard, same applies to the bottom plate portion 72a of the joint metal fitting 72 in the second embodiment mentioned above.

Further, in the column base structure 40 to be designed by the design support program, the structural calculation program and the structural calculation device according to the first embodiment mentioned above, the steel frame column 4 which is joined its lower end portion to the joint metal fitting 42 is formed as the rectangular tubular shape, however, is not limited to this shape, but may be formed, for example, as a cylindrical shape. Further, the steel frame column may be formed as a solid shape.

Further, the design support program 50 according to the first embodiment mentioned above is an independent program which is different from the structural calculation program 52, however, the design support program 50 may be embedded in the structural calculation program 52 so as to form one structural calculation program.

What is claimed is:

1. A design support program used for designing a column base structure provided with a column base portion in which a joint metal fitting arranged above a base concrete is fixed to an anchor bolt protruding upward from said base concrete, and a column member which is joined its lower end portion to an upper surface of said joint metal fitting,
wherein said column base portion is set to yield before said column member according to an increase of a load which is applied to said column base structure,
wherein a design basis strength of said joint metal fitting is set to be smaller than a design basis strength of said column member, and
wherein said design support program comprises:
a step of calculating an index bending bearing force of said column member by multiplying a bending bearing force of said column member by a value obtained by dividing the design basis strength of said joint metal fitting by the design basis strength of said column member;
a step of comparing the bending bearing force of said column base portion with the index bending bearing force of said column member; and
a step of setting the bending bearing force of said column base portion to a final bending bearing force of said column base structure in the case that the bending bearing force of said column base portion is smaller than the index bending bearing force of said column member.

2. A structural calculation program used for designing a building construction provided with a column base structure having a column base portion in which a joint metal fitting arranged above a base concrete is fixed to an anchor bolt protruding upward from said base concrete, and a column member which is joined its lower end portion to an upper surface of said joint metal fitting,
wherein said column base portion is set to yield before said column member according to an increase of a load which is applied to said column base structure,
wherein a design basis strength of said joint metal fitting is set to be smaller than a design basis strength of said column member, and
wherein said structural calculation program comprises:
a step of calculating an index bending bearing force of said column member by multiplying a bending bearing force of said column member by a value obtained by dividing the design basis strength of said joint metal fitting by the design basis strength of said column member;
a step of comparing the bending bearing force of said column base portion with the index bending bearing force of said column member;
a step of setting the bending bearing force of said column base portion to a final bending bearing force of said column base structure in the case that the bending bearing force of said column base portion is smaller than the index bending bearing force of said column member; and
a step of carrying out a structural calculation of the building construction provided with said column base structure by using the final bending bearing force of said column base structure.

3. A structural calculation program used for designing a building construction provided with a column base structure having a column base portion in which a joint metal fitting arranged above a base concrete is fixed to an anchor bolt protruding upward from said base concrete, and a column member which is joined its lower end portion to an upper surface of said joint metal fitting,
wherein said column base portion is set to yield before said column member according to an increase of a load which is applied to said column base structure,
wherein a design basis strength of said joint metal fitting is set to be smaller than a design basis strength of said column member, and
wherein said structural calculation program comprises:
a step of calculating an index bending bearing force of said column member by multiplying a bending bearing force of said column member by a value obtained by dividing the design basis strength of said joint metal fitting by the design basis strength of said column member;
a step of carrying out a structural calculation of a first virtual building construction provided with said column base structure by employing an index bending bearing force of said column member as a final bending bearing force of said column base structure;
a step of carrying out a structural calculation of a second virtual building construction in which the final bending bearing force of the column base structure in said first virtual building construction is changed to the bending bearing force of said column base portion;
a step of comparing respective structure bearing forces between said first virtual building construction and said second virtual building construction; and
a step of setting the structure bearing force of said second virtual building construction to the structure bearing force of the building construction provided with said column base structure, in the case that the structure bearing force of said virtual building construction is smaller than the structure bearing force of said first virtual building construction.
